(19) United States
(12) Patent Application Publication
(10) Pub. No.: US 2025/0109079 A1
(43) Pub. Date: Apr. 3, 2025

(54) ADDITIVE MANUFACTURABLE ENERGETIC MATERIAL, ARTICLE AND METHOD OF MANUFACTURING

(71) Applicant: Ensign-Bickford Aerospace & Defense Company, Simsbury, CT (US)

(72) Inventors: Richard Kellett, Southwick, MA (US); Andrew Rose, New Haven, CT (US)

(21) Appl. No.: 18/904,792

(22) Filed: Oct. 2, 2024

Related U.S. Application Data
(60) Provisional application No. 63/542,161, filed on Oct. 3, 2023.

(51) Int. Cl. C06B 21/00; B29C 64/118; B29K 83/00; B29K 105/00; B33Y 10/00; B33Y 70/10; B33Y 80/00; C06B 25/32

(52) U.S. Cl. CPC C06B 21/0075; B29C 64/118; B33Y 10/00; B33Y 70/10; B33Y 80/00; C06B 25/32; B29K 2083/00; B29K 2105/0094; B29K 2995/0037

(57) ABSTRACT

An additively manufactured energetic material, a method of producing an additively manufactured energetic material, and a method of making an injection moldable plastic bonded energetic material are provided. The energetic material comprises a liquid optically curable binder and an energetic material suspended in the optically curable binder.

### CROSS-REFERENCE TO RELATED APPLICATIONS

The present application is a nonprovisional of, and claims the benefit to, U.S. Provisional Application Ser. No. 63/542,161 entitled “ADDITIVE MANUFACTURING ENERGETIC MATERIAL, ARTICLE AND METHOD OF MANUFACTURING” filed on Oct. 3, 2023, the contents of which are incorporated by reference herein.

### BACKGROUND OF THE DISCLOSURE

The subject matter disclosed herein relates to energetic materials, and in particular to the fabrication of articles made from an energetic material using additive manufacturing processes.

Energetic materials, such as polymer-bonded explosive XTX-8003, have been used as a material in energetic devices. XTX-8003 is formulated from 20 percent silicone resin systems (resin plus curative) and 80 percent pentaerythritoltetranitrate (PETN). The silicone resin and PETN are mechanically mixed together and milled to eliminate entrained air. Once a final consistency is achieved, the material can be processed by injection into the desired device.

XTX-8003 has many desirably performance characteristics including flowability and low critical propagation diameter. However, the material must be stored at low temperatures, well below zero degrees Centigrade, due to resin crosslinking. Once the uncrosslinked material has been removed from cold storage, it must be introduced to the intended fixture, then any unused material is discarded. Further, even with cold storage, the material has a limited shelf life. As a result, the XTX-8003 is unsuitable for fabricating energetic devices using additive manufacturing technique.

While existing energetic materials are suitable for their intended purposes the need for improvement remains, particularly in providing an energetic material that may be processed using additive manufacturing techniques and having the features described herein.

### BRIEF DESCRIPTION OF THE DISCLOSURE

According to one aspect of the disclosure an additively manufacturable energetic material is provided. The material comprises a liquid optically curable binder and an energetic material suspended in the optically curable binder.

In addition to one or more of the features described herein, or as an alternative, further embodiments of the material may include the energetic material being a plastic bonded explosive.

In addition to one or more of the features described herein, or as an alternative, further embodiments of the material may include the plastic bonded explosive including pentaerythritoltetranitrate.

In addition to one or more of the features described herein, or as an alternative, further embodiments of the material may include the optically curable binder being an ultraviolet curable binder.

In addition to one or more of the features described herein, or as an alternative, further embodiments of the material may include the ultraviolet curable binder being a UV curable silicone.

In addition to one or more of the features described herein, or as an alternative, further embodiments of the material may include the composition being 80% w/w pentaerythritoltetranitrate.

In addition to one or more of the features described herein, or as an alternative, further embodiments of the material may include the energetic material being 1,3,5-Trinitroperhydro-1,3,5-triazine (RDX), 1,3,5,7-Tetranitro-1,3,5,7-tetrazocane (HMX), 2,6-bis(picrylamino)-3,5-dinitropyridine (PYX), Hexamethylene triperoxide diamine (HMTD) or Triacetone triperoxide (TATP)

In accordance with another aspect of the disclosure a method of producing an additively manufactured energetic article is provided. The method comprising: providing a liquid optically curable binding material; mixing an energetic material with the binding material; extruding a first layer of the energetic material-binding material mixture; emitting a light having a predetermined wavelength characteristic on the first layer; and curing the first layer with the light.

In addition to one or more of the features described herein, or as an alternative, further embodiments of the method may include repeating the steps of extruding, emitting of light, and curing a second layer, the second layer being deposited at least partially on the first layer.

In addition to one or more of the features described herein, or as an alternative, further embodiments of the method may include the energetic material being a plastic bonded explosive.

In addition to one or more of the features described herein, or as an alternative, further embodiments of the method may include the energetic material being pentaerythritoltetranitrate.

In addition to one or more of the features described herein, or as an alternative, further embodiments of the method may include the optically curable binder being an ultraviolet curable binder.

In addition to one or more of the features described herein, or as an alternative, further embodiments of the method may include the ultraviolet curable binder being UV curable silicone.

In addition to one or more of the features described herein, or as an alternative, further embodiments of the method may include the composition being 80% w/w pentaerythritoltetranitrate.

In addition to one or more of the features described herein, or as an alternative, further embodiments of the method may include the energetic material being one of 1,3,5-Trinitroperhydro-1,3,5-triazine (RDX), 1,3,5,7-Tetranitro-1,3,5,7-tetrazocane (HMX), 2,6-bis(picrylamino)-3,5-dinitropyridine (PYX), Hexamethylene triperoxide diamine (HMTD) or Triacetone triperoxide (TATP).

In accordance with another aspect of the disclosure, a method of making an injection moldable plastic-bonded energetic material is provided. The method comprising: preparing a base energetic material; preparing an optical curable binder; and mixing the base energetic material and optical curable binder to form a composition with a predetermined % w/w and achieving a predetermined viscosity between 100,000 cP to 10,000,000 cP.

In addition to one or more of the features described herein, or as an alternative, further embodiments of the method may include the energetic material being pentaerythritoltetranitrate.

In addition to one or more of the features described herein, or as an alternative, further embodiments of the method may include the optical curable binder being a UV curable binder.

In addition to one or more of the features described herein, or as an alternative, further embodiments of the method may include the UV curable binder being a silicone based curable binder.

In addition to one or more of the features described herein, or as an alternative, further embodiments of the method may include the viscosity being between 5,000,000 cP to 10,000,000 cP.

In addition to one or more of the features described herein, or as an alternative, further embodiments of the method may include the viscosity being between 150,000 cP to 250,000 cP.

In addition to one or more of the features described herein, or as an alternative, further embodiments of the method may include curing the UV curable binder with a light source emitting light at a wavelength between 365 nm to 405 nm.

In addition to one or more of the features described herein, or as an alternative, further embodiments of the method may include the composition is 80% w/w pentaerythritoltetranitrate.

In addition to one or more of the features described herein, or as an alternative, further embodiments of the method may include the energetic material being 1,3,5-Trinitroperhydro-1,3,5-triazine (RDX), 1,3,5,7-Tetranitro-1,3,5,7-tetrazocane (HMX), 2,6-bis(picrylamino)-3,5-dinitropyridine (PYX), Hexamethylene triperoxide diamine (HMTD) or Triacetone triperoxide (TATP).

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a flow diagram of a method of forming an energetic material and fabricating an energetic device in accordance with an embodiment; and

FIG. 2 is a schematic diagram of an additive manufacturing system for fabricating articles using the energetic material in accordance with an embodiment.

The detailed description explains embodiments of the disclosure, together with advantages and features, by way of example with reference to the drawings.

### DETAILED DESCRIPTION OF THE DISCLOSURE

Embodiments of the present disclosure provide for an energetic material that may be processed using additive manufacturing processes. Still further embodiments of the present disclosure provide for an optically curable energetic material that may be processed using additive manufacturing processes. In still further embodiments, the optically curable energetic material is made using a UV curable binder.

Referring now to the FIGS. an embodiment is shown of a method of formulating and processing optically curable energetic material, such as a polymer-bonded explosive for example. The process starts with a commercially available PETN that is mixed with an optically curable binder material to formulate an injection dispensible and/or moldable plastic-bonded energetic material. In an embodiment, the injection moldable plastic-bonded energetic material is an XTX-8003 explosive. It should be appreciated that while embodiments herein refer to PETN as being the energetic material, this is for example purposes and the claims should not be so limited. In other embodiments, the energetic material may include Hexamethylene triperoxide diamine (HMTD), Triacetone triperoxide (TATP), 1,3,5-Trinitroperhydro-1,3,5-triazine (sometimes referred to as RDX or hexogen), 1,3,5,7-Tetranitro-1,3,5,7-tetrazocane (sometimes referred to as HMX or octogen), or 2,6-bis(picrylamino)-3,5-dinitropyridine (sometimes referred to as PYX) as examples. In still other embodiments, the energetic material may be made from zirconium potassium perchlorate (ZPP) or other suitable energetic material typically comprising a fuel (e.g., zirconium) and an oxidizer (e.g., potassium perchlorate) mixed together with a binder. Other suitable energetic materials include, for example and without limitation, zirconium hydride potassium perchlorate (ZHPP), boron potassium nitrate (BPN), aluminum potassium perchlorate (APP), titanium potassium perchlorate (TPP), titanium hydride potassium perchlorate (THPP), and various intermetallic materials such as titanium boron, nickel aluminum, and palladium aluminum intermetallic composite particles.

Further, it should be appreciated that while embodiments herein may refer to the optically curable binder as being cured by ultraviolet (UV) light, this may include any light having a wavelength less than 400 nm. In other embodiments, the UV light may have a wavelength of 200-400 nm. In still further embodiments, the UV light may have a wavelength of 250 nm-400 nm. In still further embodiments, the optically curable binder may cure at about 365 nm, 385 nm, or 405 nm. In still further embodiments other light sources other than UV may be used, including but not limited to visible light (400 nm-700 nm), and infrared light (>700 nm). In some embodiments, it may be desirable to avoid visible light in the blue spectrum (˜450 nm-495 nm) since blue light carries more energy.

In one or more embodiments, the light source for curing the injection moldable plastic-bonded energetic material is a light emitting diode (LED). In an embodiment, the LED may be configured to have a narrow bandwidth of emitted light (e.g. <50 nm). It should be appreciated however that other suitable light sources may be used as well as is known in the art for optically curing materials.

In accordance with an embodiment, the PETN (or other suitable energetic material) is first prepared using known techniques. In some embodiments, the particle size and morphology distribution of energetic particles are configured to improve flowability of the resulting injection moldable plastic-bonded energetic material. The processing of the PETN may include a milling stage or recrystallization or blending of various powder batches. In an embodiment, the formulation for XTX-8003 uses a recrystallized PETN having a platinum based curing agent.

Once the PETN is prepared, it is mixed with an optically curable binder material. In an embodiment, the optically curable binder is curable under UV light. In an embodiment, the UV curable binder is a silicone based binder, such as UV curable silicone SE-9160 manufactured by The Dow Chemical Company. The mixing of the PETN and the binder may be performed by a suitable process, such as a hand mixing, a planetary mixer, or an acoustic mixer for example. The PETN and binder are mixed such that the resulting injection moldable plastic-bonded energetic material has a desired viscosity. In an embodiment, the injection moldable plastic-bonded energetic material viscosity may be between 100,000 cP-10,000,000 cP. In another embodiment, the viscosity may be between 5,000,000 cP-10,000,000 cp. In still further embodiments, the viscosity may be between 150,000 cP-250,000 cP.

In an embodiment, the injection moldable plastic-bonded energetic material is a composition incorporating 80% w/w of PETN.

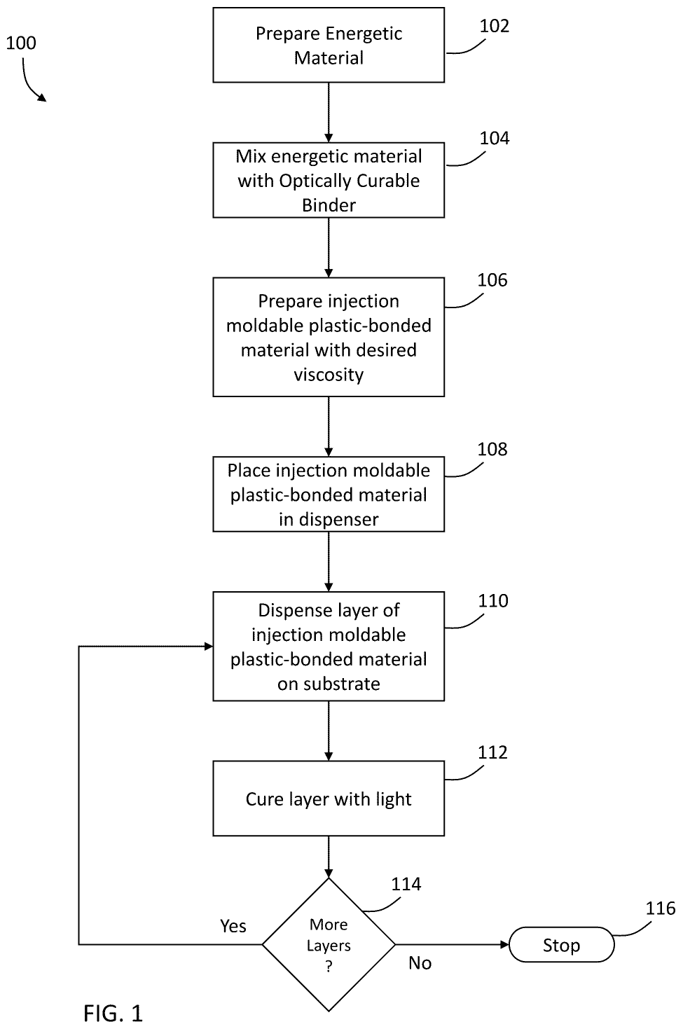

Referring now to FIG. 1, an embodiment is shown of a method 100 for preparing the injection moldable plastic-bonded energetic material and forming an energetic (e.g. pyrotechnic) article. The method 100 begins in block 102 with preparing an energetic base material, such as PETN for example, in a desired form, such as recrystallized PETN for example. The prepared energetic base material is then mixed in block 104 with an optically curable binder material, such as a UV curable silicone binder for example. The processing of the mixed energetic base and binder materials is continued in block 106 until a desired viscosity is achieved with minimal or desired level of air entrainment and the injection moldable plastic-bonded energetic material is formulated. In an embodiment the injection moldable plastic-bonded energetic material is 80% w/w of the energetic base material (e.g. PETN). In an embodiment, air entrainment is less than 10% by density. In another embodiment, air entrainment is less than 5% by density.

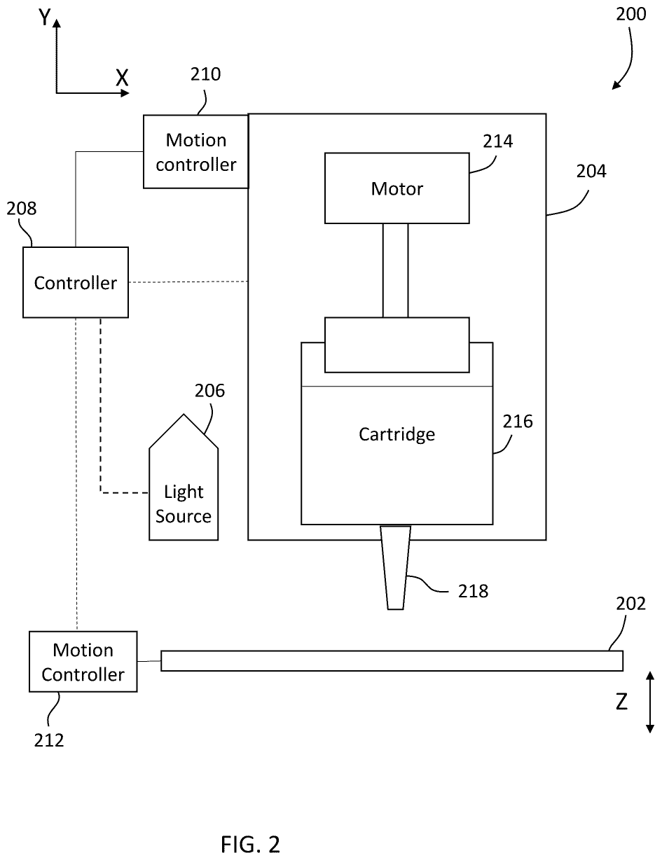

The method 100 then proceeds to block 108 where the injection moldable plastic-bonded energetic material is placed in a dispenser, such as additive manufacturing system 200 (FIG. 2) for example. It should be appreciated that additional storage steps may be performed between block 106 and block 108, such that the injection moldable plastic-bonded energetic material may be formulated at one point in time and used in a fabrication process at another later point in time.

The method then proceeds to dispense a layer of the injection moldable plastic-bonded energetic material onto a substrate, such as the bed 202 of the additive manufacturing system 200 for example, or onto the surface of another article for example. It should be appreciated that the layer may be formed into a predetermined shape on the substrate by moving one or more of the bed 202 or the dispensing unit 204 in a plane (e.g. x-y plane) or the z-direction. Further, in some embodiments, a “layer” of the injection moldable plastic-bonded energetic material dispensed onto the substrate may be formed in multiple segments that may be separately cured for example. In still further embodiments, multiple layers of the injection moldable plastic-bonded energetic material may be deposited on the substrate (or underlying layers) and then cured simultaneously.

Once a layer (or a segment of a layer) is deposited on the substrate, the method 100 proceeds to block 112 where the deposited layer is cured using a light source, such as a light source 206 for example. After curing the layer, the method 100 proceeds to query block 114 where it is determined is the article being fabricated needs additional layers. When the query block 114 returns a positive (more layers are needed), the method 100 loops back to block 110 where the additional layer is deposited. It should be appreciated that this loop of depositing a layer, curing, and then determining whether additional layers are needed may continue until the article being fabricated is completed. Once the query block 114 returns a negative, the method 100 stops in block 116.

It should be appreciated that a number of types of additive manufacturing processes may be used to fabricate a target object using the injection moldable plastic-bonded energetic material. For example, when the injection moldable plastic-bonded energetic material is formulated with a lower viscosity, an additive manufacturing process such as an inkjet printing may be used to deposit the layers. Referring now to FIG. 2, an example of an additive manufacturing system 200 having a dispensing unit 204 is shown. In this embodiment, the system 200 includes a controller 208 that is operably coupled to the dispensing unit 204, a light source 206, an optional dispenser motion controller 210 and an optional bed motion controller 212. It should be appreciated that the system 200 may include one or more motion controllers 210, 212 that operate to move one or more of the bed 202 and dispensing unit 204 to allow the system to generate one or more layers of the injection moldable plastic-bonded energetic material in a predetermined pattern.

In an embodiment, the motion controller 210 may include one or more motors, slides, rails, or other structure as is known in the art to move the dispensing unit 204 with a desired degree of freedom. In the example embodiment, the motion controller 210 moves the dispensing unit 204 in a plane perpendicular to the page of FIG. 2 (an X-Y plane). In other embodiments, the motion controller 210 may move the dispensing unit 204 in three (three translational), four (three translational, one rotational), five (three translational, two translational), or six (three translational, three rotational) degrees of freedom or any combination of the foregoing. In the example embodiment, the motion controllers 212 includes one or more motors, slides, rails or other structure known in the art to move the bed vertically (Z-direction). It should be appreciated that similar to the motion controller 210, in other embodiments the motion controller 210 may be configured to move the bed in three (three translational), four (three translational, one rotational), five (three translational, two translational), or six (three translational, three rotational) degrees of freedom or any combination of the foregoing.

In an embodiment, the light source 206 may be coupled to the dispensing unit 204, or may be separately mounted. In an embodiment, the light source 206 is separately movable relative to the dispensing unit 204.

In an example embodiment, the dispensing unit 204 includes a motor 214 or other similar device configured to cause a predetermined amount of injection moldable plastic-bonded energetic material to be dispensed from a material storage member, such as cartridge 216 for example. In response to actuation of the motor 214 (which may be controlled by the controller 208), the injection moldable plastic-bonded energetic material flows through a nozzle 218 onto a substrate or previously deposited layer. In an embodiment, the dispensing unit may be similar to a SmartValve model dispenser manufactured by Fishman Dispensing Corporation of Hopkinton, Massachusetts, USA. It should be appreciated that other types of dispensers may also be used, such as a syringe type dispenser for example. Further, the injection moldable plastic-bonded energetic material may be stored in other types of containers, such as a hopper for example.

In operation, the operator would generate a model of the target object to be fabricated, such as a computer aided design (CAD) model for example. In an embodiment, the model is processed using software commonly referred to as a “slicer” that generates numerical control computer code, sometimes referred to as “G-code,” that deconstructs the model into a plurality of discrete layers. This numerical control computer code is transmitted to the controller 208 to control the motion controllers 210, 212, dispensing unit 204 and light source 206 during operation. Once the injection moldable plastic-bonded energetic material is loaded into the cartridge 216, the layers of injection moldable plastic-bonded energetic material may be dispensed onto the substrate (or previously deposited layers) and cured to fabricate the target object.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It should also be noted that the terms “first”, “second”, “third”, “upper”, “lower”, and the like may be used herein to modify various elements. These modifiers do not imply a spatial, sequential, or hierarchical order to the modified elements unless specifically stated.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. An additively manufacturable energetic material comprising:
a liquid optically curable binder; and
an energetic material suspended in the liquid optically curable binder.

2. The energetic material of claim 1, wherein the energetic material is plastic bonded explosive.

3. The energetic material of claim 2, where the plastic bonded explosive includes pentaerythritoltetranitrate.

4. The energetic material of claim 1, wherein the liquid optically curable binder is an ultraviolet curable binder.

5. The energetic material of claim 4, wherein the ultraviolet curable binder is UV curable silicone.

6. The energetic material of claim 5, wherein the energetic material is 80% w/w pentaerythritoltetranitrate.

7. The energetic material of claim 1, wherein the energetic material is 1,3,5-Trinitroperhydro-1,3,5-triazine (RDX), 1,3,5,7-Tetranitro-1,3,5,7-tetrazocane (HMX), 2,6-bis(picrylamino)-3,5-dinitropyridine (PYX), Hexamethylene triperoxide diamine (HMTD) or Triacetone triperoxide (TATP).

8. A method of producing an additively manufactured energetic article, the method comprising:
providing a liquid optically curable binding material;
mixing an energetic material with the liquid optically curable binding material;
extruding a first layer of the energetic material-binding material mixture;
emitting a light having a predetermined wavelength characteristic on the first layer; and
curing the first layer with the light.

9. The method of claim 8, further comprising repeating the steps of extruding, emitting of the light, and curing a second layer, the second layer being deposited at least partially on the first layer.

10. The method of claim 9, wherein the energetic material is a plastic bonded explosive.

11. The method of claim 9, wherein the energetic material is pentaerythritoltetranitrate.

12. The method of claim 11, wherein:
the liquid optically curable binding material is an ultraviolet curable binder; and
the ultraviolet curable binder is UV curable silicone.

13. The method of claim 12, wherein the energetic material is 80% w/w pentaerythritoltetranitrate.

14. The method of claim 12, wherein the energetic material is 1,3,5-Trinitroperhydro-1,3,5-triazine (RDX), 1,3,5,7-Tetranitro-1,3,5,7-tetrazocane (HMX), 2,6-bis(picrylamino)-3,5-dinitropyridine (PYX), Hexamethylene triperoxide diamine (HMTD) or Triacetone triperoxide (TATP).

15. A method of making an injection moldable plastic-bonded energetic material, the method comprising:
preparing a base energetic material;
preparing an optical curable binder; and
mixing the base energetic material and the optical curable binder to form a composition with a predetermined % w/w and achieving a predetermined viscosity between 100,000 cP to 10,000,000 cP.

16. The method of claim 15, wherein:
the composition is pentaerythritoltetranitrate;
the optical curable binder is a UV curable binder; and
the UV curable binder is a silicone based curable binder.

17. The method of claim 16, wherein the composition has a viscosity of between 5,000,000 cP to 10,000,000 cP.

18. The method of claim 16, further comprising curing the UV curable binder with a light source emitting light at a wavelength between 365 nm to 405 nm.

19. The method of claim 15 wherein the composition is 80% w/w pentaerythritoltetranitrate.

20. The method of claim 15, wherein the composition includes 1,3,5-Trinitroperhydro-1,3,5-triazine (RDX), 1,3,5,7-Tetranitro-1,3,5,7-tetrazocane (HMX), 2,6-bis(picrylamino)-3,5-dinitropyridine (PYX), Hexamethylene triperoxide diamine (HMTD) or Triacetone triperoxide (TATP).
